(19) United States
(12) Patent Application Publication
(10) Pub. No.: US 2006/0128387 A1
(43) Pub. Date: Jun. 15, 2006

(54) Method of providing multimedia messaging service

(76) Inventor: In Kwon Kim, SEOUL (KR)

Correspondence Address: Law Offrices of Royal W Craig, 10 N Calvert Street, Suite 153, Baltimore, MD, 21202, US

(21) Appl. No.: 10/543,023

(22) PCT Filed: Jan. 28, 2004
(86) PCT No.: PCT/KR04/00141

§ 371 Date: Jul. 22, 2005

(30) Foreign Application Priority Data
Jan. 29, 2003 (KR) 10-2003-0005949

(51) Int. Cl. H04Q 7/20

(52) U.S. Cl. 455/445

(57) ABSTRACT

If a recipient's mobile communication terminal supports a multimedia messaging service (MMS), previously stored MMS data are read out. If not so, only short message service (SMS) data among the MMS data are read out. The retrieved MMS or SMS data are transmitted to the recipient's mobile communication terminal via a mobile communication repeater. When text data are input through a sender's mobile communication terminal while the transmission of a message is requested by the sender's mobile communication terminal, the text data are transmitted together with the MMS or SMS data to the recipient's mobile communication terminal.

### TECHNICAL FIELD

The present invention relates to a method for providing a multimedia messaging service (hereinafter, referred to as “MMS”), wherein a sender using a mobile communication terminal configures in advance certain MMS data including moving pictures, combined images (also referred to as so-called “avatar”), images of business cards and the like, background music and text data, which are desired by the sender, and the configured MMS data are transmitted from the sender's mobile communication terminal to a recipient's mobile communication terminal designated by the sender.

### BACKGROUND ART

With the development of information and communication technologies, changes in living patterns, and high economic growth, the pattern of communication culture is rapidly changed. In a technetronic society, a mobile communication system capable of providing a communication service at basements, in the air, on the sea and even at mountains regardless of time and place according to consumers' needs for information transfer at high speed becomes one of important communication media indispensable to daily life.

In the mobile communication system, mobile communication terminals can support a short messaging service (hereinafter, referred to as “SMS”) and thus transmit given text data with a size of 80 bytes or less to one another. Recently, there has been developed and used MMS that is a more upgraded service overcoming the capacity limitation of SMS, wherein a great deal of information can be transmitted at one time, and it is possible to transmit various kinds of data including not only text data but also combined images, images of business cards and the like, moving pictures, background music and the like.

In a conventional method for providing MMS through transmission of MMS data using mobile communication terminals, a sender connects his/her mobile communication terminal with the Internet in a wired or wireless manner or with his/her computer in a wired manner, downloads certain MMS data from the Internet or computer, and stores them in his/her terminal. Further, MMS data received from other mobile communication terminals have been previously stored in the sender's terminal. In this state, the sender selects MMS data to be transmitted among the stored MMS data and instructs the sender's terminal to transmit the selected MMS data while inputting a phone number of a recipient's mobile communication terminal through the sender's terminal. At this time, the sender's terminal transmits the MMS data together with the recipient's phone number to a mobile communication repeater. The mobile communication repeater transmits the MMS data to the recipient's terminal corresponding to the phone number so that the recipient can check the transmitted MMS data.

However, in the case where MMS data are transmitted by means of such a conventional MMS method, both the sender's and recipient's mobile communication terminals should support MMS. If any one of the sender's and recipient's mobile communication terminals does not support MMS, MMS data cannot be transmitted. Moreover, there is a lot of inconvenience in that upon transmission of MMS data, a sender should select MMS data to be transmitted one by one. In addition, there are problems in that since selected MMS data are uploaded on a mobile communication repeater and then transmitted to a recipient's mobile communication terminal, it takes much time to transmit the MMS data.

### DISCLOSURE OF INVENTION

Accordingly, an object of the present invention is to provide a method for providing MMS, wherein a sender configures in advance certain desired MMS data, and a sender's mobile communication terminal transmits the previously configured MMS data to a recipient's mobile communication terminal when the sender requests the transmission of a message.

Another object of the present invention is to provide a method for providing MMS, wherein when a sender inputs text data through a sender's mobile communication terminal, the text data are transmitted together with MMS data previously configured by the sender to a recipient's mobile communication terminal.

A further object of the present invention is to provide a method for providing MMS, wherein MMS data previously configured by a sender are transmitted to a recipient's mobile communication terminal whenever the sender requests the transmission of a message while inputting a phone number of the recipient's terminal through a sender's mobile communication terminal.

A still further object of the present invention is to provide a method for providing MMS, wherein MMS data can be transmitted to a recipient's mobile communication terminal regardless of whether a sender's mobile communication terminal supports MMS.

A still further object of the present invention is to provide a method for providing MMS, wherein it is determined whether a recipient's mobile communication terminal supports MMS, and MMS data configured by a sender are transmitted to the recipient's terminal if the recipient's terminal supports MMS, or only SMS data extracted from the MMS data configured by the sender are transmitted to the recipient's terminal if the recipient's terminal supports MMS.

In a method for providing MMS according to the present invention for achieving the objects, a personal terminal of a subscriber is connected with a MMS server to configure MMS data and store the configured MMS data in a relevant subscriber area of a database. If a message is requested to be transmitted from a sender's mobile communication terminal to a recipient's mobile communication terminal, the MMS server reads out data previously stored in the subscriber area and transfers the data to a mobile communication repeater via a mobile communication company's server to allow the data to be transmitted to a recipient's mobile communication terminal.

As for the storage of the MMS data, if the personal terminal connects with the MMS server and requests a selection of MMS data, a list of MMS data stored in a MMS data area of the database is displayed so that MMS data can be selected. If certain MMS data are selected through the personal terminal, the selected MMS data are displayed and it is determined whether the selected MMS data will be configured as MMS data for the subscriber. If the MMS data are not configured as MMS data for the subscriber, the operation for displaying the list of MMS data is repeated so that MMS data can be selected. If the MMS data are configured as MMS data for the subscriber, the configured MMS data are stored in the relevant subscriber area of the database. Further, if the personal terminal connects with the MMS server and requests a selection of MMS data, MMS data are received from the personal terminal and the received MMS data are stored in the relevant subscriber area of the database.

As for the reading of the data stored in the subscriber area, if a message is requested to be transmitted from the sender's mobile communication terminal to the recipient's mobile communication terminal, the mobile communication company's server provides the MMS server with sender's and recipient's phone numbers and information on the recipients mobile communication terminal. The MMS server determines whether the recipient's mobile communication terminal supports MMS, based on the provided information on the recipient's mobile communication terminal. If it is determined that the recipient's mobile communication terminal supports MMS, the MMS data stored in the relevant subscriber area of the database for a sender are read out. If it is determined that the recipient's mobile communication terminal does not support MMS, only SMS data included in the MMS data stored in the relevant subscriber area of the database for the sender are read out.

As for the transmission of the MMS data, it is determined whether text data are input through the sender's mobile communication terminal. If it is determined that text data are input therethrough, the text data are transferred together with the read MMS data to the mobile communication repeater via the mobile communication company's server to allow the both data to be transmitted to the recipient's mobile communication terminal.

Further, in the method of the present invention, the sender's mobile communication terminal connects with an ARS system, MMS data are configured according to the guidance of the ARS system, and the MMS sever stores the configured MMS data in the relevant subscriber area of the database.

### BRIEF DESCRIPTION OF DRAWINGS

FIG. 1 is a block diagram showing the configuration of a MMS system to which a method for providing MMS according to the present invention is applied.

FIG. 2 is a flowchart illustrating an operation for configuring MMS data through a personal terminal by a subscriber in the method for providing MMS according to the present invention.

FIG. 3 is a flowchart illustrating an operation for configuring MMS data through connection with an ARS system by a subscriber in the method for providing MMS according to the present invention.

FIG. 4 is a flowchart illustrating an operation for transmitting MMS data to a recipient's mobile communication terminal in the method for providing MMS according to the present invention.

### BEST MODE FOR CARRYING OUT THE INVENTION

Hereinafter, a method for providing MMS according to the present invention will be described in detail with reference to the accompanying drawings.

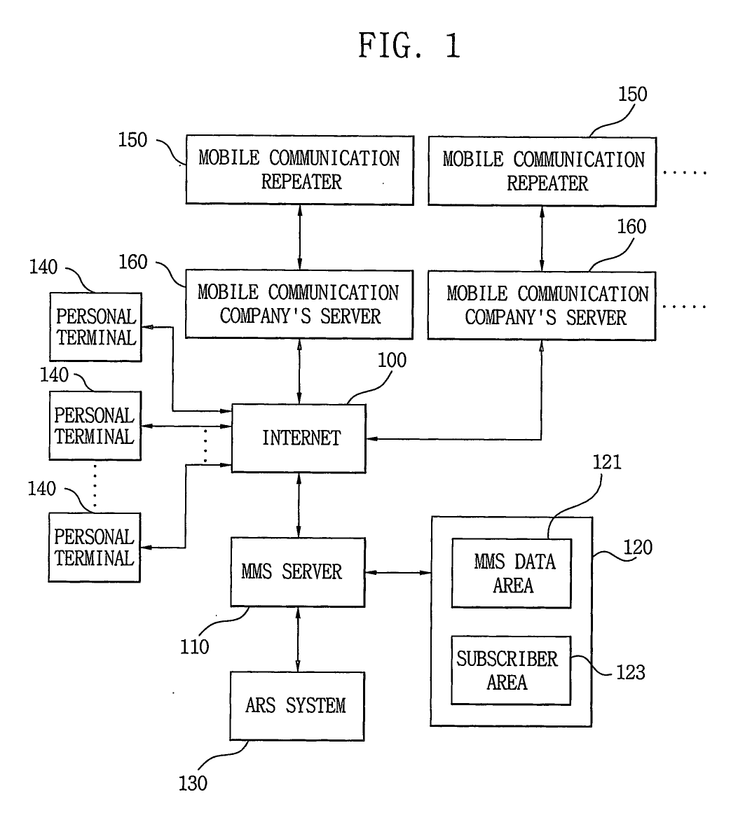

FIG. 1 is a block diagram showing the configuration of a MMS system to which a method for providing MMS according to the present invention is applied. Here, reference numeral 100 designates the Internet that is a data communication network based on Transmission Control Protocol/Internet Protocol (TCP/IP), reference numeral 110 is a MMS server, and reference numeral 120 is a database connected to the MMS server 110. The database 120 comprises a MMS data area 121 for storing a plurality of pieces of MMS data, and a subscriber area 123 for storing MMS data configured by a subscriber to the MMS server 110.

Reference numeral 130 designates an ARS system connected with the MMS server 110. When a mobile communication terminal (not shown) connects with the ARS system 130, the ARS system 130 performs voice guidance on MMS data stored in the MMS data area 121 of the database 120 and notifies the MMS server 110 of MMS data selected by the mobile communication terminal so that the MMS data can be stored in the subscriber area 123 of the database 120.

Reference numerals 140 designate a plurality of personal terminals, such as personal computers, mobile communication terminals and personal digital assistants (PDAs) having an Internet access function, used by a plurality of subscribers. Each personal terminal 140 connects with the MMS server 110 through the Internet 100 and receives guidance on MMS data stored in the MMS data area 121 of the database 120. Then, the personal terminal 140 selects the guided MMS data and causes them to be stored in the subscriber area 123 of the database 120, or transmits MMS data inputted directly through the personal terminal 140 to the MMS server 110 and causes them to be stored in the subscriber area 123 of the database 120.

Reference numerals 150 designate a plurality of mobile communication repeaters for connecting the mobile communication terminals to one another so that phone calls can be made and MMS data can be transmitted, and reference numerals 160 designate a plurality of mobile communication companies' severs. Each server 160 determines whether a sender has subscribed to the MMS server 110, based on the phone number of a mobile communication terminal of the sender announced over the relevant mobile communication repeater 150. If it is determined that the sender is a subscriber, the server 160 notifies the MMS server 110 of the determination results through the Internet 100 to receive MMS data configured by the subscriber, and inputs the received MMS data into the mobile communication repeater 150 so that they can be controlled to be transmitted to a recipient's mobile communication terminal.

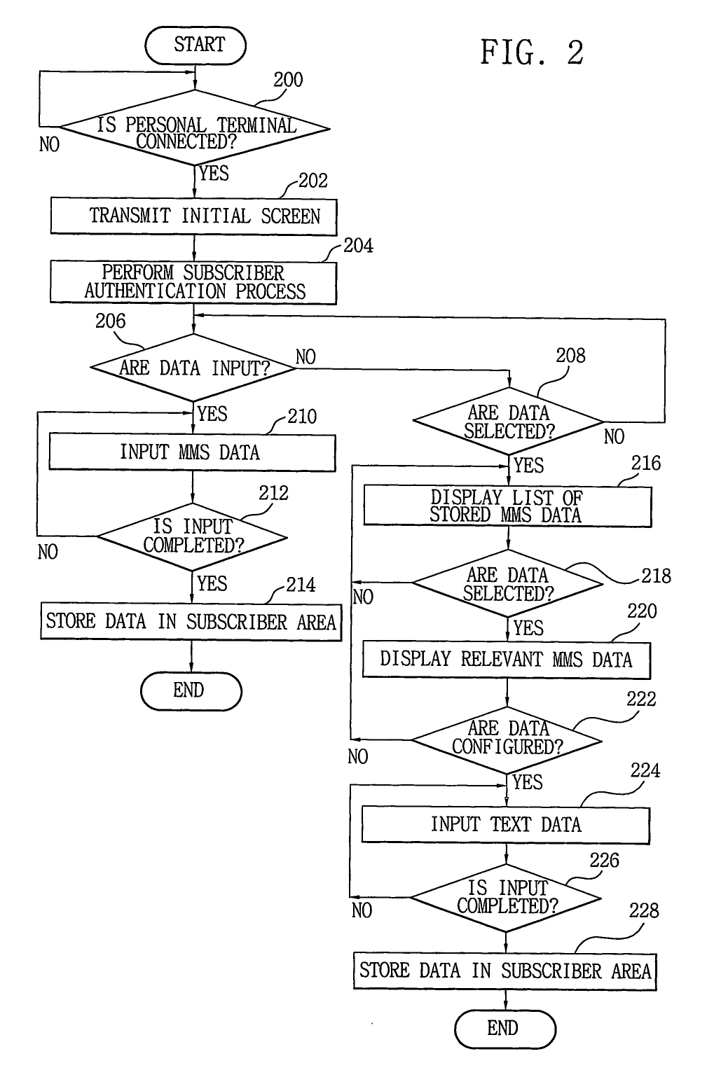

According to the method of the present invention applied to the MMS system constructed as such, as illustrated in FIG. 2, when a personal terminal 140 such as a personal computer, a mobile communication terminal or a PDA having an Internet access function connects with the MMS server 110 through the Internet 100 in step 200, the MMS server 110 transmits an initial screen to the personal terminal 140 through the Internet 100 in step 202 and performs a subscriber authentication process through the transmitted initial screen in step 204 to determine whether a user of the personal terminal 140 is a subscriber. If the user is not a subscriber, the MMS server 110 advises the user to subscribe as a member thereof. At this time, if the user of the personal terminal 140 subscribes as a member, the MMS server 110 configures a subscriber area 123 for storing MMS data selected by the relevant subscriber in the database 120.

When the subscriber authentication process is completed, the MMS server 110 determines in step 206 whether the subscriber's personal terminal 104 requests direct input of MMS data or in step 208 whether it requests a selection of MMS data stored in the MMS data area of the database 120.

If it is determined in step 206 that the personal terminal 140 requests the direct input of MMS data, the MMS server 110 receives MMS data inputted from the personal terminal 140 in step 210. In step 212, the MMS server 110 determines whether the input of the MMS data has been completed. If it is determined that the input of the MMS data has not been completed, the MMS data are continuously received in step 210. If it is determined in step 212 that the input of the MMS data has been completed, the MMS server 110 transmits the received MMS data to the database 120 in step 214 so that they can be stored in a relevant subscriber area 123.

If the person terminal 140 requests a selection of MMS data in step 208, the MMS server 110 transmits a list of MMS data stored in the MMS data area 121 of the database 120 to the personal terminal 140 to display the list in step 216. If certain MMS data are selected from the displayed list through the personal terminal 140 in step 218, the MMS server 110 reads out the selected MMS data from the MMS data area 121 of the database 120 and transmits the read MMS data to the personal terminal 140 so that the MMS data can be displayed and confirmed in step 220. Then, the MMS server 110 determines in step 222 whether the MMS data are configured in the personal terminal 140.

If it is determined in step 222 that the MMS data are not configured in the personal terminal 140, the procedure returns to step 216 so that other MMS data can be selected and confirmed.

If it is determined in step 222 that the MMS data are configured in the personal terminal 140, the MMS server 110 receives given text data, which will be transmitted together with the MMS data, from the personal terminal 140 in step 224. If the input of the text data is completed in step 226, the MMS server 110 stores the configured MMS data and the inputted text data in the relevant subscriber area 123 of the database 120 in step 228.

The present invention constructed as above allows a user to connect with the MMS server 110 through the Internet 100 using the personal terminal 140 with the Internet access function such as a personal computer, a mobile communication terminal or a PDA and to select desired certain MMS data among MMS data stored in the database 120, or to transmit certain MMS data through the personal terminal 140 so that the MMS data can be stored in advance in a subscriber area of the database 120.

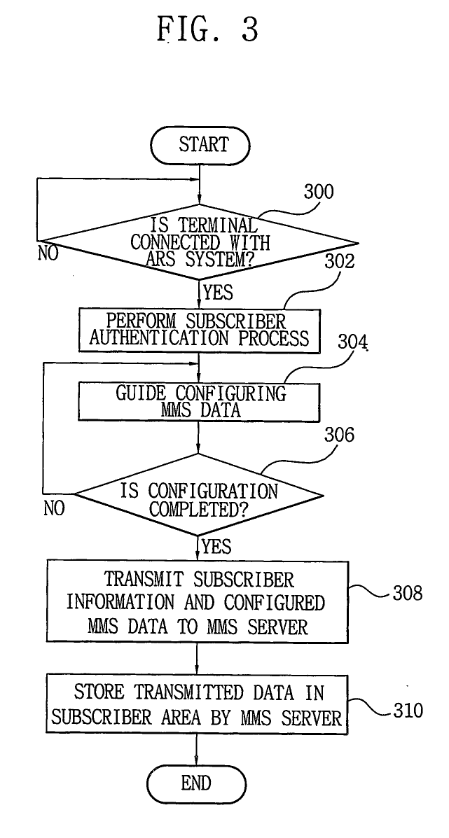

FIG. 3 is a flowchart illustrating an operation for configuring MMS data through connection with an ARS system by a subscriber in the method for providing MMS according to the present invention. As illustrated in the figure, if a mobile communication terminal connects with an ARS system 130 in step 300, the ARS system 130 performs a subscriber authentication process while performing given voice guidance in step 302. For example, if a user is not a subscriber, the ARS system performs voice guidance so that the user can subscribe as a member. If the user is a subscriber, the ARS system authenticates the subscriber by receiving a password and the like therefrom. At this time, the ARS system 130 informs the MMS server 110 of information on a subscriber that has subscribed as a member, so that the MMS server can create a subscriber area 123 in the database 120.

If the subscriber authentication process is completed, the ARS system 130 guides configuring MMS data in step 304 and then determines in step 306 whether the MMS data have been completely configured. For example, the MMS data have been classified according to types thereof, and the ARS system 130 performs voice guidance on the classified MMS data one by one and transmits MMS data selected by the subscriber to the mobile communication of the subscriber so that the subscriber can confirm and configure the transmitted MMS data. At this time, if the mobile communication terminal of the subscriber does not support MMS, the ARS system 130 can transmit only audio data such as background music among MMS data to the mobile communication terminal of the subscriber. Thus, although the subscriber can confirm and configure the audio data, he/she cannot configure images, moving pictures or the like. If the mobile communication terminal of the subscriber supports MMS, the ARS system 130 can transmit all of background music, images and moving pictures among MMS data to the mobile communication terminal of the subscriber so that the subscriber can confirm and configure all of them.

When MMS data are completely configured in such a state, the ARS system 130 transfers subscriber information and MMS data configured by the subscriber to the MMS server 110 in step 308. Then, the MMS server 110 inputs the configured MMS data into the database 120 to store them in the relevant subscriber area 123.

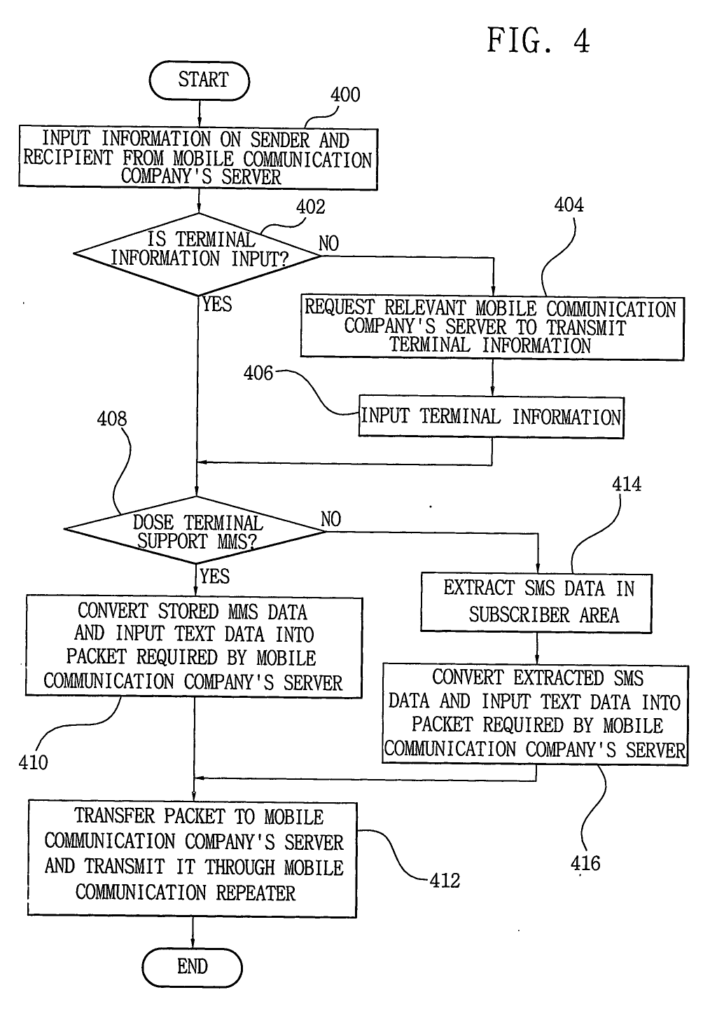

FIG. 4 is a flowchart illustrating an operation for transmitting MMS data configured by a subscriber to a recipient in the method for providing MMS according to the present invention. As illustrated in the figure, if a sender inputs a given phone number of a recipient's mobile communication terminal through a sender's mobile communication terminal and requests transmission of messages (MMS data) configured by himself/herself, or inputs and transmits certain text data, the mobile communication company's server 160 connected with the mobile communication repeater 150 confirms, based on a phone number of the sender, whether the sender is a subscriber to the MMS server 110. If it is confirmed that the sender is a subscriber, the server 160 inputs information on the sender and the recipient into the MMS server 110 through the Internet 100 in step 400. Here, the information inputted into the MMS server 110 by the server 160 includes, for example, sender's phone number, recipient's phone number, certain text data input through the mobile communication terminal by the sender, information on whether the recipient's mobile communication terminal supports MMS, and the like.

Then, the MMS server 110 determines in step 402 whether the input data include information on whether the recipient's mobile communication terminal supports MMS. If it is determined that the input data do not include information on whether the recipient's mobile communication terminal supports MMS, in step 404, the MMS server 110 requests a relevant mobile communication company's server 160 to which the recipient's mobile communication terminal subscribes to transmit information on whether the recipient's mobile communication terminal supports MMS. In step 406, the MMS server receives the information on whether the recipient's mobile communication terminal supports MMS from the relevant server 160. That is, in a case where the sender and the recipient have subscribed to an identical mobile communication company, since information on the recipient's mobile communication terminal is stored in a server 160 for the relevant mobile communication company, the MMS server 110 can be informed of the information on the recipient's mobile communication terminal. On the contrary, in a case where the sender and the recipient have subscribed to different mobile communication companies, since the information on the recipient's mobile communication terminal is not stored in a server 160 for a relevant mobile communication company to which the sender has subscribed, the MMS server 110 cannot be informed of the information. Therefore, if it is determined in step 402 whether information inputted from the server 160 includes information on the recipient's mobile communication terminal and it is then determined that information on the recipient's mobile communication terminal is not included therein, the MMS sever requests a server 160 for a relevant mobile communication company to which the recipient has subscribed to transmit information on the recipient's mobile communication terminal in step 404 and then receives the information in step 406.

In subsequent step 408, the MMS server 110 determines whether the recipient's mobile communication terminal supports MMS. If it is determined that the recipient's mobile communication terminal is a mobile communication terminal capable of supporting MMS, the MMS server converts MMS data stored in the subscriber area 123 corresponding to the sender's phone number and text data inputted by the sender through his/her mobile communication terminal into a predetermined packet required by the server 160 in step 410 and transfers the converted packet to the server 160 through the Internet 100 in step 412. The server 160 transfers the packet inputted from the MMS server 110 to the mobile communication repeater 150 so that the packet can be transmitted to the recipient's mobile communication terminal.

If it is determined in step 408 that the recipient's mobile communication terminal is not a mobile communication terminal capable of supporting MMS, only SMS data are extracted from the MMS data stored in the subscriber area 123 of the database 120 corresponding to the sender's phone number in step 414. That is, since moving pictures, images and the like cannot be displayed on a screen of a mobile communication terminal that cannot support MMS, only SMS data are extracted from the subscriber area 123 for the sender.

In subsequent step 416, the MMS server 110 converts the extracted SMS data and text data inputted by the sender through his/her mobile communication terminal into the predetermined packet required by the server 160. Then, the MMS server transfers the converted packet to the server 160 through the Internet 100 in step 412. The server 160 transfers the packet inputted from the MMS server 110 to the mobile communication repeater 150 so that the packet can be transmitted to the recipient's mobile communication terminal. At this time, if the size of the SMS data and text data exceeds the capacity of a mobile communication terminal capable of supporting SMS, i.e. 80 bytes, the SMS data and text data are split into data sets of 80 bytes to create a plurality of packets. The plurality of created packets are sequentially transmitted to the mobile communication repeater 150 that in turn transmits them to the recipient's mobile communication terminal.

According to the present invention described above, a sender that is a subscriber stores in advance certain desired MMS data in a database of a MMS server and the stored MMS data are transmitted to a recipient's mobile communication terminal. At this time, MMS data or SMS data can be transmitted according to the type of the recipient's mobile communication terminal regardless of whether a sender's mobile communication terminal supports MMS. Further, if the sender inputs text data through the sender's mobile communication terminal, the text data can be transmitted together with MMS data configured by the sender. In addition, there is an advantage in that MMS data are not necessarily configured one by one whenever MMS data are transmitted.

Although the present invention has been described and illustrated in connection with the specific preferred embodiment of the present invention, it can be readily understood by those skilled in the art that various modifications and changes can be made thereto without departing from the spirit and scope of the invention defined by the appended claims.

1. A method for providing a multimedia messaging service (MMS), comprising the steps of:
(a) connecting a personal terminal of a subscriber with an Internet access function to a MMS server, configuring MMS data, and storing the configured MMS data in a relevant subscriber area of a database;
(b) if certain data are inputted through a sender's mobile communication terminal and then transmitted to a recipient's mobile communication terminal, reading out, by the MMS server, data from the MMS data previously stored in the subscriber area in step (a), the read data being selected according to whether the recipient's mobile communication terminal supports MMS; and
(c) transferring the MMS data read in step (b) and the data inputted through the sender's mobile communication terminal to a mobile communication repeater via a mobile communication company server to allow the both data to be transmitted to the recipient's mobile communication terminal;
wherein step (b) comprises the steps of:
(b-1) if certain data are requested to be transmitted from the sender's mobile communication terminal to the recipient's mobile communication terminal, providing the MMS server with sender's and recipient's phone numbers and information on the recipient's mobile communication terminal by the mobile communication company's server;
(b-2) determining, by the MMS server, whether the recipient's mobile communication terminal supports MMS, based on information on the recipient's mobile communication terminal provided in step (b-1);
(b-3) if it is determined in step (b-2) that the recipient's mobile communication terminal supports MMS, reading out the MMS data stored in the relevant subscriber area of the database for a sender; and
(b-4) if it is determined in step (b-2) that the recipient's mobile communication terminal does not support MMS, reading out only SMS data included in the MMS data stored in the relevant subscriber area of the database for the sender.

2. The method as claimed in claim 1, wherein step (a) comprises the steps of:
(a-1) if the personal terminal connects with the MMS server and requests a selection of MMS data, displaying a list of MMS data stored in a MMS data area of the database to select MMS data;
(a-2) if certain MMS data are selected through the personal terminal in step (a-1), displaying the selected MMS data and determining whether the selected MMS data will be configured as MMS data for the subscriber;
(a-3) if the MMS data are not configured as MMS data for the subscriber in step (a-2), repeating the operation for displaying the list of MMS data to select MMS data; and
(a-4) if the MMS data are configured as MMS data for the subscriber in step (a-2), storing the configured MMS data in the relevant subscriber area of the database.

3. The method as claimed in claim 2, wherein step (a) further comprises the steps of:
(a-5) if the personal terminal connects with the MMS server and requests a selection of MMS data, receiving MMS data from the personal terminal; and
(a-6) storing the MMS data received in step (a-5) in the relevant subscriber area of the database.

4. The method as claimed in any one of claims 1 to 3, wherein the personal terminal with the Internet access function is a personal computer, a mobile communication terminal or a personal digital assistant (PDA).

5. The method as claimed in claim 1, further comprising the step of:
(d) connecting a mobile communication terminal with an ARS system, configuring MMS data according to guidance of the ARS system, and storing, by the MMS sever, the configured MMS data in the relevant subscriber area of the database.
